(19) United States
(12) Patent Application Publication
(10) Pub. No.: US 2019/0145152 A1
(43) Pub. Date: May 16, 2019

(54) SYSTEM AND METHOD FOR USING A DETACHABLE LOCK-BOX DEVICE

(71) Applicant: Safemark Systems Inc., Orlando, FL (US)

(72) Inventors: Scott Nelson, Apopka, FL (US); Marc Barber, Deltona, FL (US)

(21) Appl. No.: 15/809,950

(22) Filed: Nov. 10, 2017

(51) Int. Cl. E05G 1/00; E05G 1/024; E05B 65/00

(52) U.S. Cl. CPC E05G 1/005; G06Q 50/12; E05B 65/0075; E05G 1/024

(57) ABSTRACT

A detachable lock-box device may include a set of walls defining a compartment. At least one of the walls may define an aperture. A door may be rotatably coupled to the set of walls that, when in a closed position, forms a fully enclosed lock-box. An electromechanical lock assembly may be configured to enable a user to lock and unlock the door. A connector pin assembly may be configured to secure to an object and at least partially insert into the aperture. A securing component may be configured to detachably connect to a portion of the connector pin assembly such that when the securing component is attached to the connector pin assembly, the detachable lock-box box is secured to the object. The detachable lock-box device may be secured to an object using a variety of methods.

### BACKGROUND

Hotel safes or lock-boxes that are typically positioned in closets have long been used to enable hotel guests to lock their valuables within the safes for security purposes. These safes typically have a keypad via which a user enters a 4-digit security code to lock and unlock the lock-boxes. Historically, the lock-boxes have been basic in their design, where a lock-box has been configured with a door on which a keypad and lock mechanism are fixedly attached to operate as a user interface. While such lock-boxes have been functionally operational, such lock boxes do not meet all the needs of a guest. Guests oftentimes need secure storage options for items, such as smartphones and wallets, while enjoying hotel amenities, such as pools and beachside accommodations. Additionally, others require secure public storage options when attending public events, such as concerts and music festivals, and while in public spaces, such as hospitals and schools. As such, there is a need for secure lock-box devices that may be made available in public venues that allow for individuals to securely store their valuables.

### SUMMARY

In order to provide hotel and resort guests and other users with operation of a lock-box in public areas, such as pool side, provided is a detachable lock-box device. A detachable lock-box device may include a set of walls defining a compartment. At least one of the walls may define an aperture. A door may be rotatably coupled to the set of walls that, when in a closed position, forms a fully enclosed lock-box. An electromechanical lock assembly may be configured to enable a user to lock and unlock the door. A connector pin assembly may be configured to secure to an object and at least partially be inserted into the aperture. A securing component may be configured to detachably connect to a portion of the connector pin assembly such that when the securing component is attached to the connector pin assembly, the detachable lock-box box is secured to the object.

Also provided is a process of securing a lock-box device to an object. The method may include providing a fastener configured to be secured to an object. A connector pin attached to the fastener may be provided, and be configured to be inserted into an aperture of a wall of the lock-box. The securing component may be enabled to secure the connector pin in the aperture to prevent the connector pin from being extracted from the lock-box device.

### BRIEF DESCRIPTION OF THE DRAWINGS

Illustrative embodiments of the present invention are described in detail below with reference to the attached drawing figures, which are incorporated by reference herein and wherein:

FIGS. 1A-1C are views of a chair, such as a chaise lounge, with a detachable lock-box device securely affixed to a member of the chair;

FIGS. 2A-2C are illustrations showing various mounting positions that can be employed to securely attached a detachable lock-box device to a chair;

FIGS. 3A-3D are views of an illustrative detachable lock-box device securely affixed to a chair;

FIGS. 4A-4C are views of an illustrative lock-box device configured in a detached form;

FIG. 5 is a view of the inside compartment of the lock-box device;

FIGS. 6A and 6B are views of an illustrative connector pin and fastener (connector pin assembly); and

FIG. 7 is an illustration of an illustrative securing member used to secure a connector pin to prevent the lock-box from being detached from an object to which the connector pin assembly is attached; and

FIG. 8 is an illustrative flow diagram of a process for providing and/or using a securable lock-box, as provided herein.

### DETAILED DESCRIPTION OF THE DRAWINGS

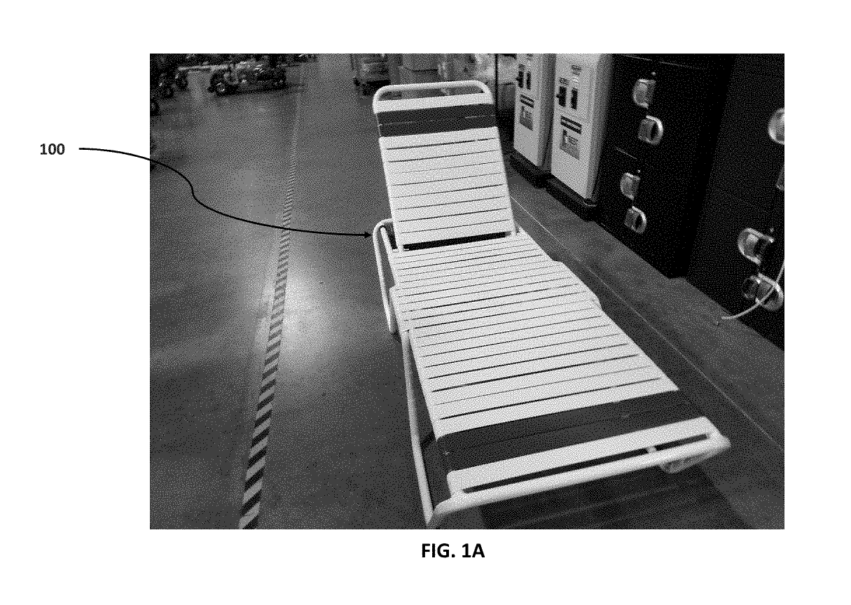

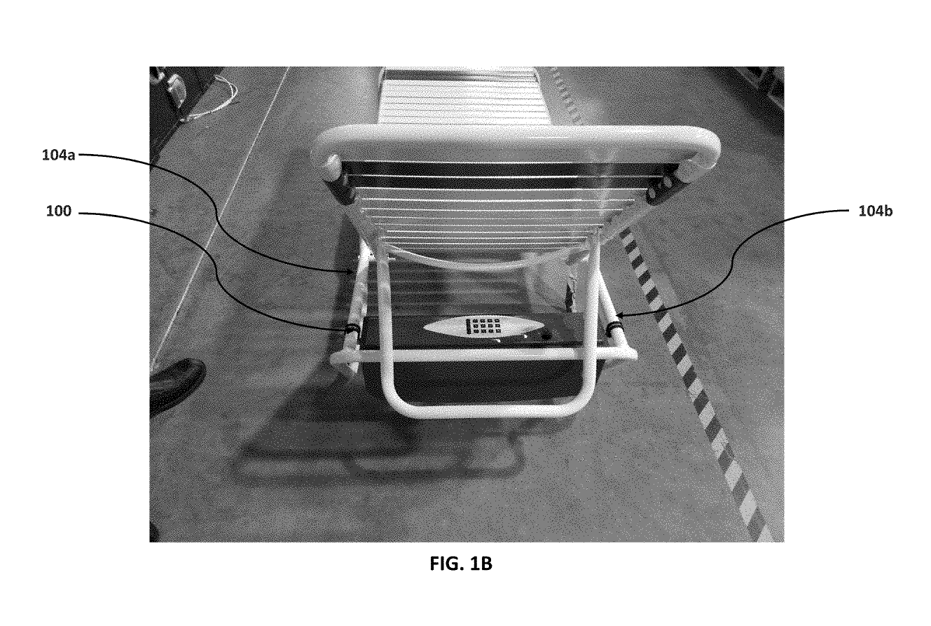

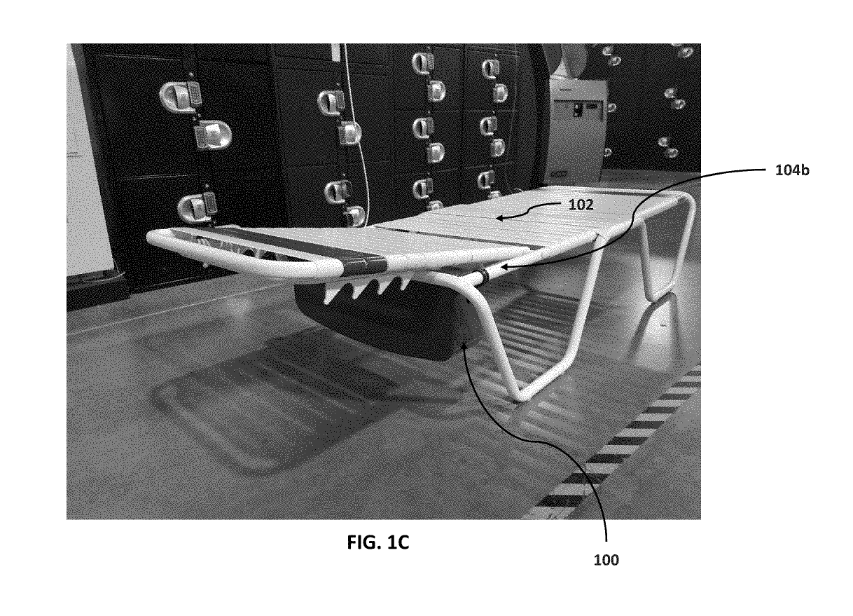

With regard to FIGS. 1A-1C, an illustrative detachable lock-box device 100 may be attached to everyday objects, such as a lounge chair 102. As shown in FIG. 1A, the detachable lock-box device 100 has a profile such that it is not readily visible to a passerby, thus enhancing the security of the device. As shown in FIGS. 1B and 1C, the lock-box device 100 may be connected between a pair of frame members 104a and 104b of the chair 102, as further described herein. It should be understood that the object may include any other moveable or fixed object to which a securing mechanism, as further described herein.

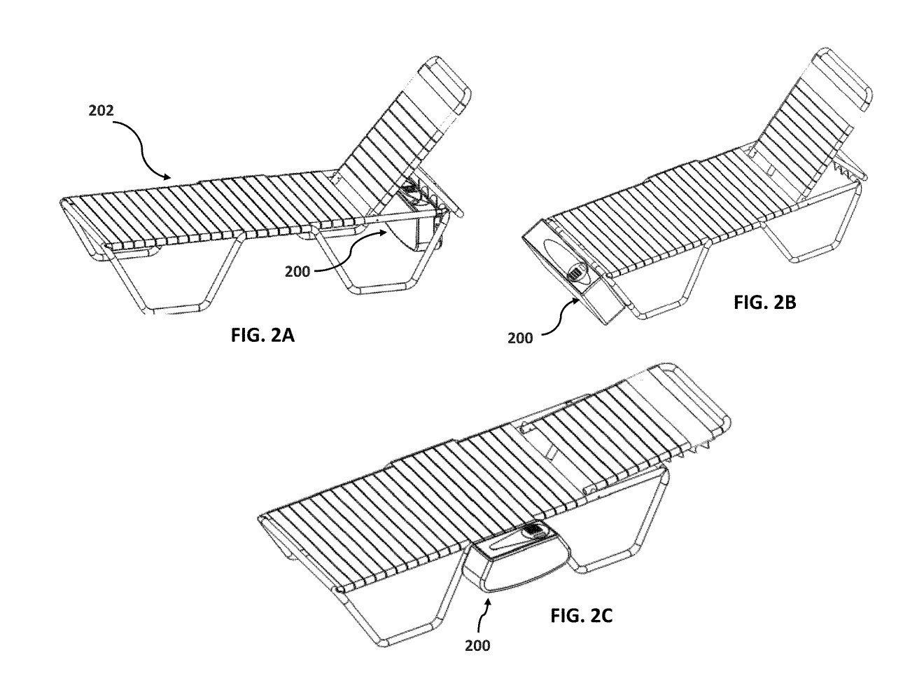

As shown in FIGS. 2A, 2B, and 2C, the detachable lock-box device 200 may be mounted to an object 202 in any location where the detachable lock-box device 200 can be securely affixed to the object 202. As shown in FIG. 2A, the detachable lock-box device 200 can be securely affixed to the under and/or backside of the object 202, in this case a chaise lounge. As shown in FIG. 1B, the detachable lock-box device can be securely affixed to an end of an object. As shown in FIG. 2C, the detachable lock-box device 200 can be securely affixed to a side of an object.

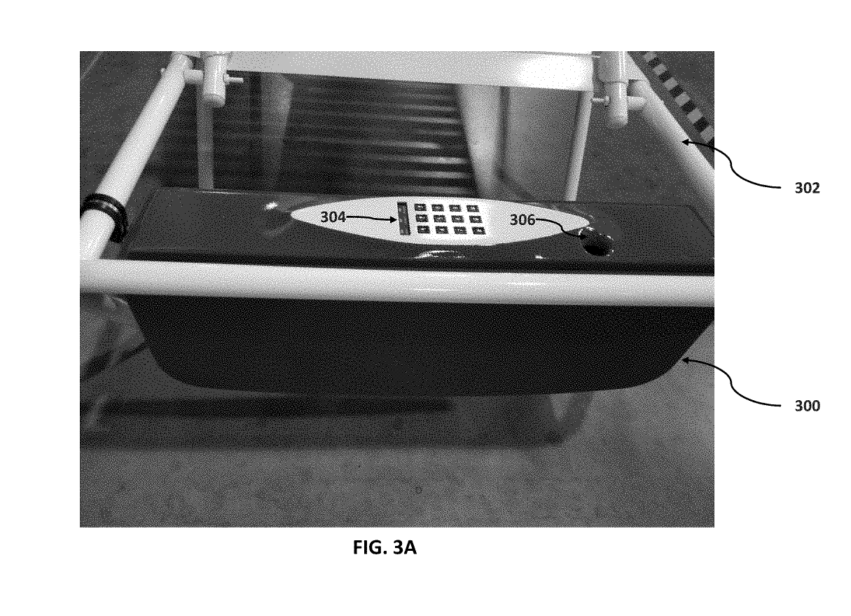

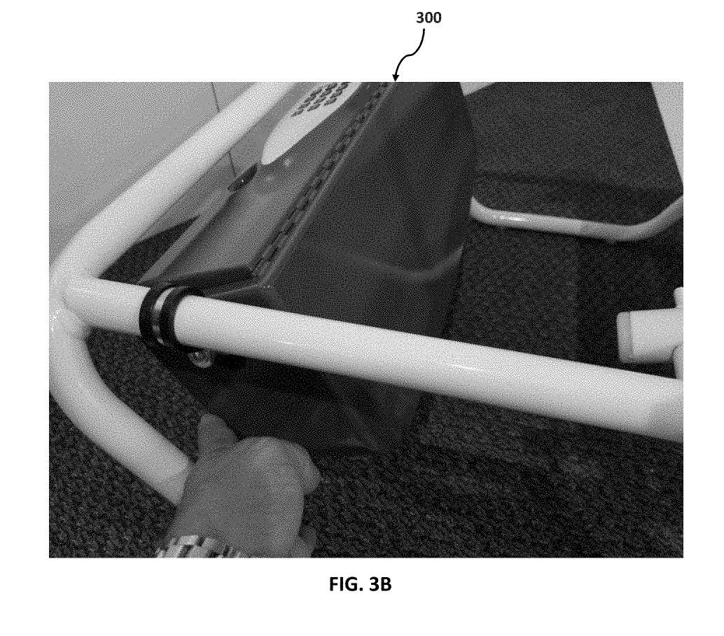

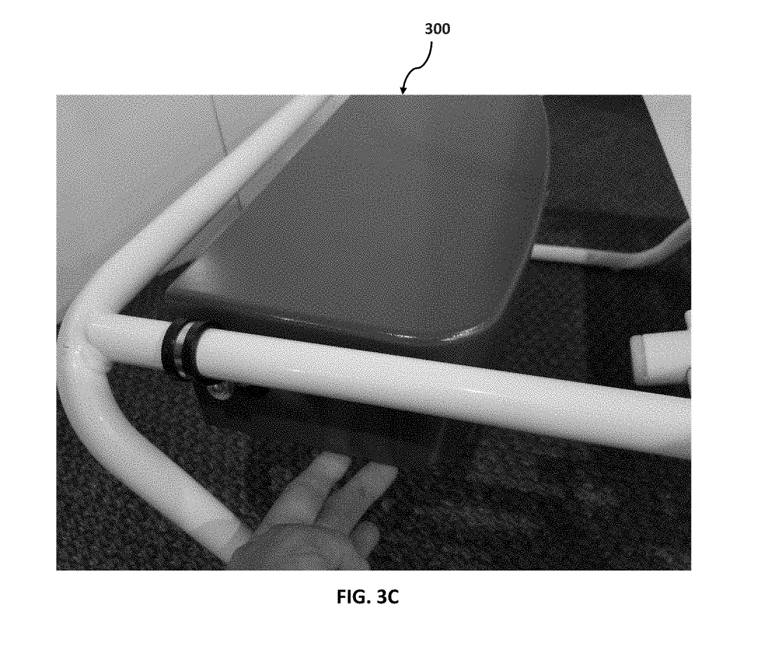

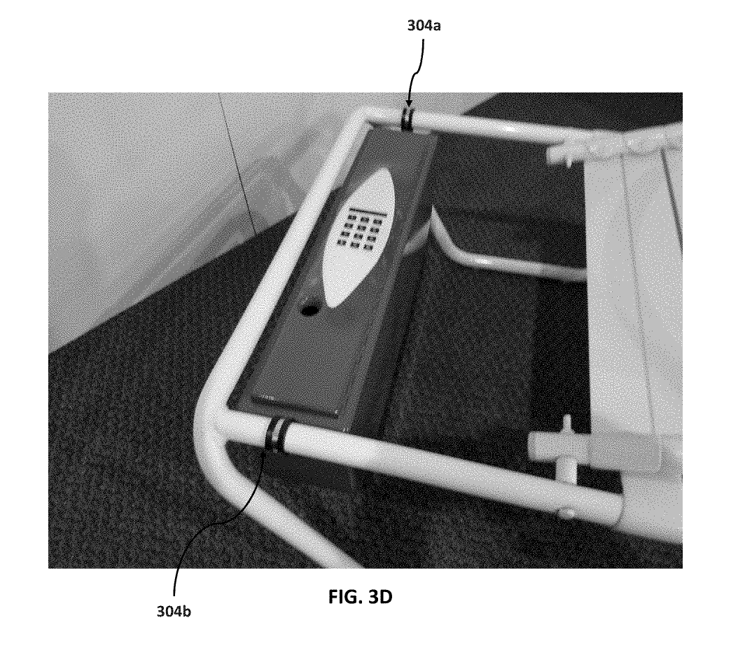

As shown in FIG. 3A, an illustrative detachable lock-box device 300 can hang freely once securely affixed to an object 302, in this case a chair. As shown in FIGS. 3B and 3C, the detachable lock-box device 300 can hang freely and rotate, or at least change positions, once securely affixed to an object. By being able to rotate, the object 302 to which the detachable lock-box device 300 is attached may be able to be stacked or otherwise arranged with other objects, and the detachable lock-box device 300 may accommodate such stacking or rearrangement for storage or other purposes. As shown in FIG. 3D, the detachable lock-box device can be attached to at least two points 304a and 304b. In other embodiments, the detachable lock box device 300 may be securely affixed to a single point. In other embodiments, the detachable lock-box device 300 may be securely affixed to more than two points of the object. The detachable lock-box device 300 may include an electromechanical lock mechanism 304 with a user interface having a keypad, display, and or any other mechanism for locking and unlocking a door of the detachable lock-box device 300. An opening 306 may enable a mechanical key to override the electromechanical lock mechanism 304 in the event that a user forgets the combination or the electromechanical lock mechanism 304 fails in some manner. The electomechanical lock mechanism may operate the same or similar to that as provided in co-pending U.S. application Ser. No. 14/586,822; the contents of which are incorporated by reference herein in their entirety.

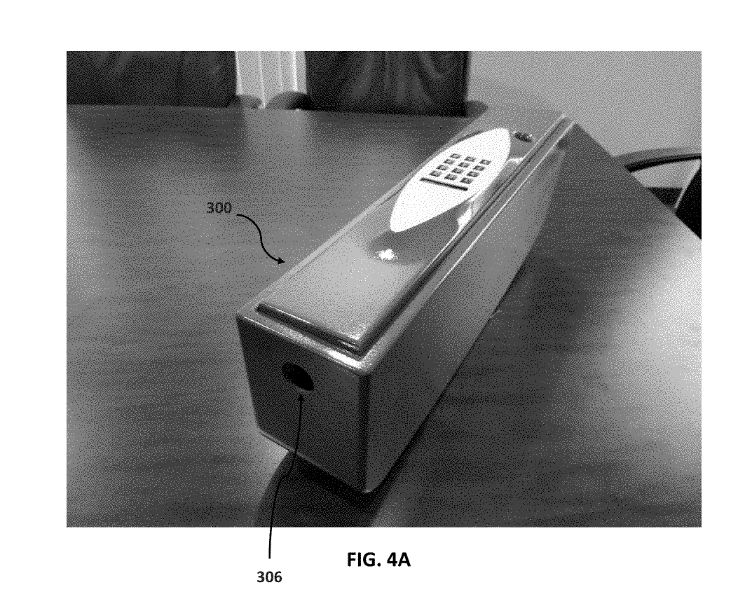

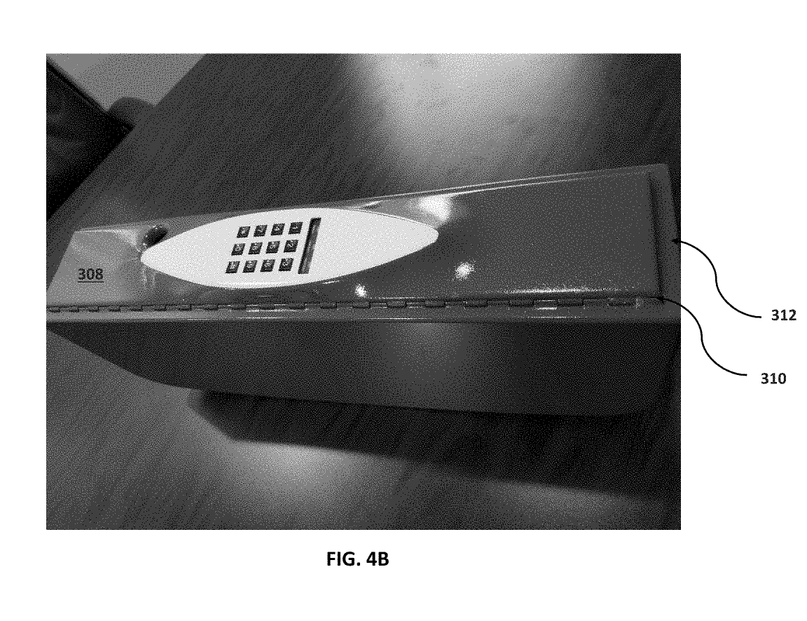

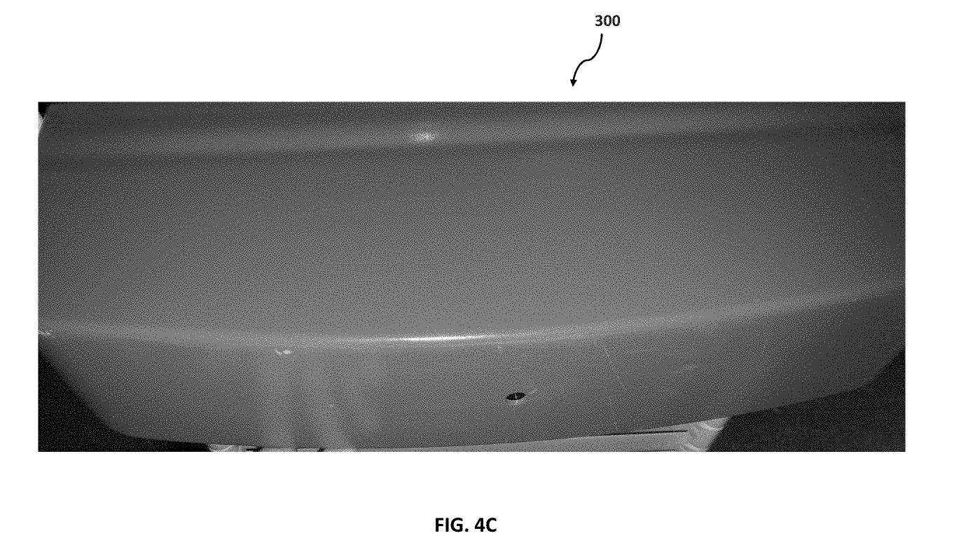

As shown in FIG. 4A, the detachable lock-box device 300 has at least one wall defining at least one aperture 306 with a diameter sufficient to allow insertion of a connector pin to allow for the detachable lock-box device 300 to be securely affixed to an object. As shown in FIG. 4B, the detachable lock-box device 300 has a door 308 that is rotatably coupled by a hinge 310 to a wall 312 for allowing access to an inside compartment defined by the walls and door 308. In some embodiments, the door 308 is hinged on a shorter axis of the wall 312. In other embodiments, such as the one shown in FIG. 4B, the door 308 is hinged on a longer axis. FIG. 4C is an illustration of a rear side view of the detachable lock-box device 300.

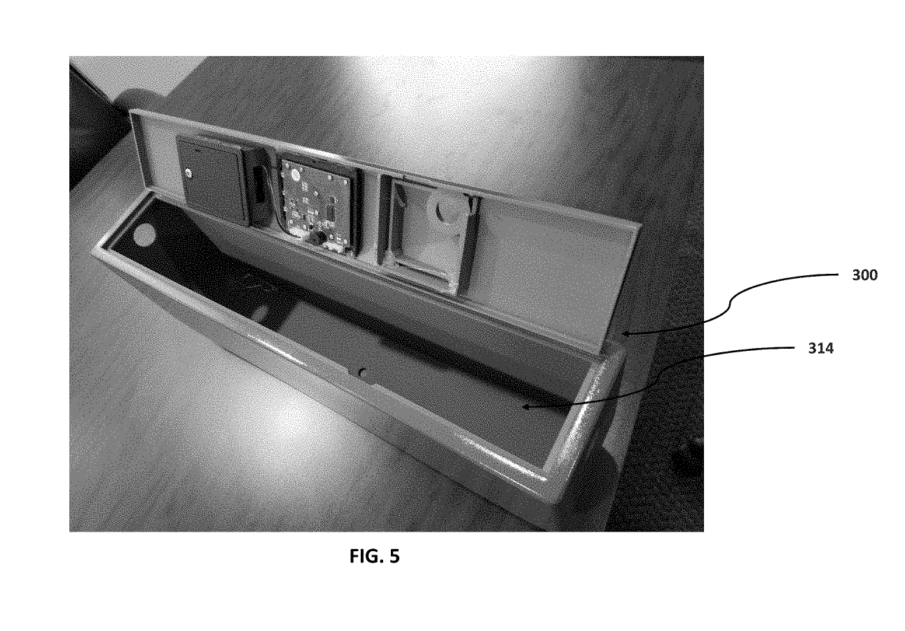

As shown in FIG. 5, an illustrative compartment 314 of the detachable lock-box device 300 is sufficiently sized (e.g., 2-inches×12-inches) to allow for storage of valuables therein.

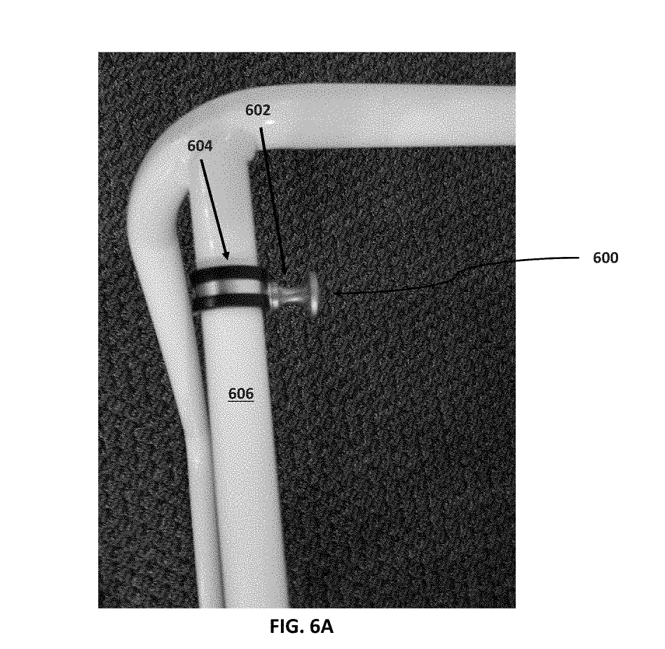

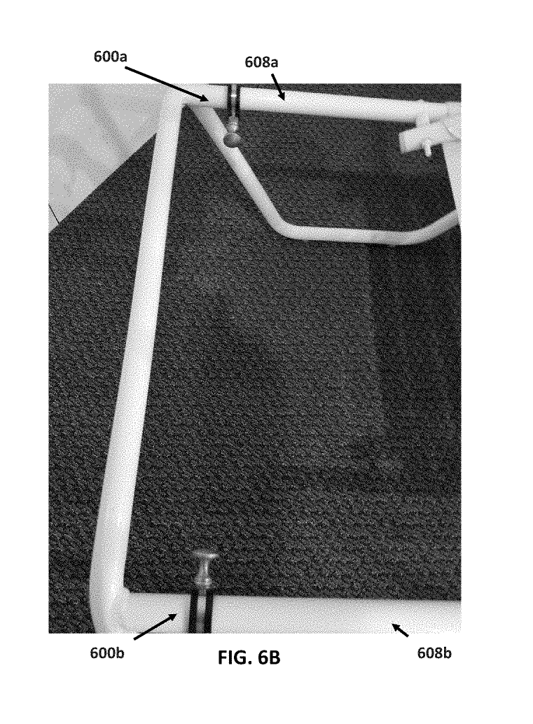

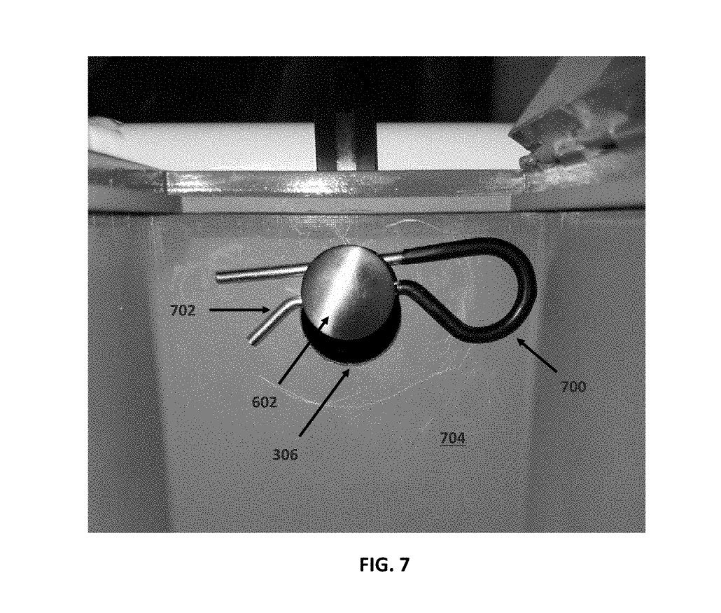

As shown in FIG. 6, an illustrative connector pin assembly 600 includes a connector pin 602 and a fastener 604. The connector pin 602 may be configured as a clevis pin, and a complimentary cotter pin (see FIG. 7) may be used to prevent the connector pin 602 from being separated from the lock-box device. The fastener 604 may be a flexible member that is capable of wrapping around a member of an object 606, in this case a tubular frame member 606 of a chair. The fastener 604 may be flexible and be formed of a variety of different materials (e.g., polymer or rubber, plastic, etc.) that are capable of being stretched, bent, twisted, or otherwise. In an embodiment, a metal, metal alloy, or other material that is difficult to cut may be disposed within the fastener 604 to reduce the ability for someone to separate the fastener 604 from the object. Still yet, the fastener 604 may be a combination of metal and polymer to reduce or prevent the fastener 604 from sliding on a member of the object to which the fastener 604 is connected. In an embodiment, the fastener 604 is a single material formed with a gap along a center portion that enables the fastener 604 to be pulled over the connector pin 602 to secure the connector pin assembly 600 onto the frame member 606. Other configurations are possible (e.g., loop of metal and/or other material that defines an opening through which the connector pin 602 inserts to prevent the fastener 604 from releasing from the member of the object. It should be understood that a wide variety of configurations of the fastener 604 may be utilized. In an alternative embodiment, the fastener 604 may be stiff, and a hinged member (not shown) may be capable of opening and closing around a member of an object.

FIG. 6B shows a set of two connect pin assemblies 600a and 600b that may be used to secure a detachable lock-box device (e.g., detachable lock-box device 200) on two members 608a and 608b of an object (e.g., chair).

With regard to FIG. 7, an illustration of an illustrative securing member used to secure a connector pin 602 to prevent the lock-box device from being detached from an object to which the connector pin assembly is attached is shown. The pin 602 is shown to be extended through the aperture 306 of FIG. 4A of a wall of the detachable lock-box device 300. A securing component 700, such as a cotter pin, is shown to have a portion 702 extended through an aperture defined by the connector pin 602. In an embodiment, the securing component 700 may be attached to an inside wall 704 of the lock-box device. The attachment may include the use of a tether, fastening member, or any other configuration that prevents the securing component 700 from being removed from the inside of the lock-box device. In an alternative embodiment, a securing component may be a rotatable member that is attached to the wall 704 that surrounds a head of the connector pin 602 (i.e., a shaft of the pin is thinner than the head, and the securing component operates as a “fork” that prevents the head of the connector pin 602 from being extracted from the inside of the lock-box device. In other embodiments, the securing component includes a clasp, a lock, a pinching device or other device (not shown) to secure or assist in securing the connector pin or head of the connector pin such that it prevents the head of the connector pin from being extracted from the inside of the lock-box device.

In some embodiments, quick release securing components inside the compartment allow for removal (detachment) of the detachable lock-box device. In some embodiments, the detachable lock box safe is not removable without unlocking the lock box.

In yet further embodiments, the lock-box is secured to an object using a fastener that includes a locking mechanism on the outer side of the lock box and locks or unlocks when the lock box is locked and unlocked. In such embodiments, a connector pin may or may not be used.

In further embodiments, the lock-box may be secured to a chair, to a fence or wall structure, to bleachers, or to any other similar objects to which a connector member may be used to secure the detachable lock-box device.

According to certain embodiments, provided is a detachable lock-box device including a set of walls defining a compartment, at least one of the walls defining an aperture; a door rotatably coupled to the set of walls that, when in a closed position, forms a fully enclosed lock-box; an electromechanical lock assembly configured to enable a user to lock and unlock the door; a connector pin assembly configured to secure to an object and at least partially insert into the aperture, and a securing component configured to detachably connect to a portion of the connector pin assembly such that when the securing component is attached to the connector pin assembly the detachable lock-box box is secured to the object. In further embodiments, the connector pin assembly includes a flexible fastener configured to be secured to the object and a connector pin configured to at least partially insert into the aperture. In further embodiments, the connector pin assembly includes a hinge member configured to be secured to the object and a connector pin configured to at least partially insert into the aperture.

In yet further embodiments, at least two walls of the set of walls define an aperture, and further include at least two connector pin assemblies and at least two securing components configured to secure to the object and connector pin assemblies. In other embodiments, the securing component is secured to an inside surface of the set of walls such that when the electromechanical lock assembly is locked, the securing component is inaccessible to the user or anyone else. In some embodiments, the securing component is rotatably connected to the inside surface. In yet other embodiments, the securing component is tethered to the inside surface.

In yet further embodiments, the connector pin assembly includes a female member that defines an opening, and wherein the connector pin assembly includes a male pin member that is configured to be inserted into the opening of the female pin member to prevent the female pin member from being removed from the aperture until the male pin member is removed from the female pin member. In other embodiments, the electromechanical lock assembly includes a user interface that enables the user to set a code that locks and unlocks the electromechanical lock assembly. In further embodiments, the securing component is automatically activated in response to the electromechanical lock assembly being locked and unlocked. In further embodiments, the object to which the detachable lock-box is secured is a chair, a bleacher, or a fence.

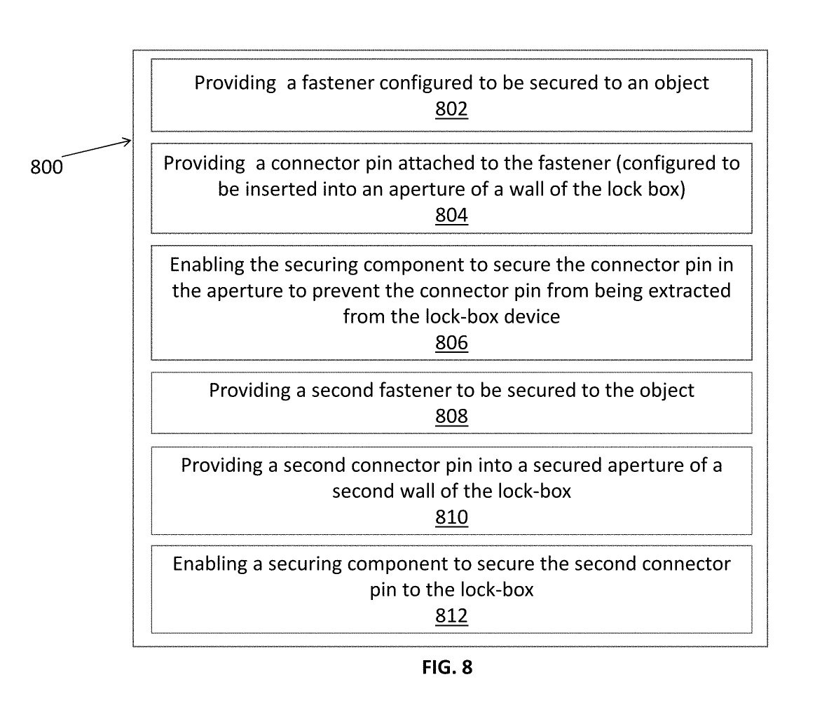

According to certain embodiments, as shown in FIG. 8, also provided is a method of securing a lock-box device to an object. The method 800 may include step 802 of providing a fastener configured to be secured to an object. At step 804, a connector pin attached to the fastener may be provided, and be configured to be inserted into an aperture of a wall of the lock-box. At step 806, the securing component may be enabled to secure the connector pin in the aperture to prevent the connector pin from being extracted from the lock-box device. In an optional embodiment, the method further includes step 808 for providing a second fastener to the object. At step 810, a second connector pin may be provided and be configured to be inserted into an aperture of a second wall of the lock-box. At step 812, a securing component may be enabled to secure the second connector pin to the lock-box. In further embodiments, the object to which the detachable lock-box is secured is a chair.

In certain embodiments of the method, the fastener is a flexible fastener configured to be secured to the object. In other embodiments, the fastener includes a hinge configured to be secured to the object. In yet further embodiments, the securing component is secured to an inside surface of the set of walls such that when the electromechanical lock assembly is locked, the securing component is inaccessible to the user or anyone else. In some embodiments, the securing component is rotatably connected to the inside surface. In other embodiments, the securing component is tethered to the inside surface. In yet other embodiments, the chair is located outside.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed:

1. A detachable lock-box device, comprising:
a set of walls defining a compartment, at least one of the walls defining an aperture;
a door rotatably coupled to said set of walls that, when in a closed position, forms a fully enclosed lock-box;
an electromechanical lock assembly configured to enable a user to lock and unlock said door;
a connector pin assembly configured to secure to an object and at least partially insert into the aperture, and
a securing component configured to detachably connect to a portion of said connector pin assembly such that when said securing component is attached to said connector pin assembly the detachable box is secured to the object.

2. The lock-box device according to claim 1, further wherein said connector pin assembly includes a flexible fastener configured to be secured to said object and a connector pin configured to at least partially insert into the aperture.

3. The lock-box device according to claim 1, further wherein said connector pin assembly includes a hinge member configured to be secured to said object and a connector pin configured to at least partially insert into the aperture.

4. The lock-box device according to claim 1, wherein at least two walls of the set of walls define an aperture, and further including at least two connector pin assemblies and at least two securing components configured to secure to the object and connector pin assemblies.

5. The lock-box according to claim 1, wherein said securing component is secured to an inside surface of said set of walls such that when said electromechanical lock assembly is locked, said securing component is inaccessible to the user or anyone else.

6. The lock-box according to claim 5, wherein said securing component is rotatably connected to the inside surface.

7. The lock-box according to claim 5, wherein said securing component is tethered to the inside surface.

8. The lock-box according to claim 1, wherein said connector pin assembly includes a female member that defines an opening, and wherein said connector pin assembly includes a male pin member that is configured to be inserted into the opening of the female pin member to prevent the female pin member from being removed from the aperture until the male pin member is removed from the female pin member.

9. The lock-box according to claim 1, wherein said electromechanical lock assembly includes a user interface that enables the user to set a code that locks and unlocks said electromechanical lock assembly.

10. The lock-box according to claim 1, wherein said securing component is automatically activated in response to said electromechanical lock assembly being locked and unlocked.

11. The lock-box according to claim 1, wherein the object is a chair.

12. A method of securing a lock-box device to an object, comprising:
providing a fastener configured to be secured to an object;
providing a connector pin attached to the fastener, and configured to be inserted into an aperture of a wall of the lock-box;
enabling the securing component to secure the connector pin in the aperture to prevent the connector pin from being extracted from the lock-box device.

13. The method according to claim 12, further comprising:
providing a second fastener to be secured to the object;
providing a second connector pin into a secured aperture of a second wall of the lock-box; and
enabling a securing component to secure the second connector pin to the lock-box.

14. The method according to claim 12, wherein the object is a chair.

15. The method according to claim 12, further wherein the fastener is a flexible fastener configured to be secured to said object.

16. The method according to claim 12, further wherein the fastener includes a hinge configured to be secured to said object.

17. The method according to claim 12, wherein said securing component is secured to an inside surface of said set of walls such that when said electromechanical lock assembly is locked, said securing component is inaccessible to the user or anyone else.

18. The method according to claim 12, wherein said securing component is rotatably connected to the inside surface.

19. The method according to claim 12, wherein said securing component is tethered to the inside surface.

20. The method according to claim 14, wherein the chair is located outside.
